(19) United States
(12) Patent Application Publication
(10) Pub. No.: US 2026/0067683 A1
(43) Pub. Date: Mar. 5, 2026

(54) AEROSPACE-BASED KEY INJECTION

(71) Applicant: Wells Fargo Bank, N.A., San Francisco, CA (US)

(72) Inventors: Peter Burton Bordow, Fountain Hills, AZ (US); Jeff J. Stapleton, Fort Worth, TX (US)

(21) Appl. No.: 18/824,189

(22) Filed: Sep. 4, 2024

(51) Int. Cl. H04W 12/0431; H04W 12/041

(52) U.S. Cl. CPC H04W 12/0431; H04W 12/041

(57) ABSTRACT

System and techniques for aerospace-based key injection are described herein. An aerospace platform can receive a request for an initial key from an entity. This request includes an identifier for the entity that is unique among a set of entities to which the entity belongs. The aerospace platform uses a local base derivation key and the received identifier to generate an initial key for the entity. The initial key is then transmitted to the entity.

### TECHNICAL FIELD

Embodiments described herein generally relate to encrypted communications for terminal devices and more specifically to aerospace-based key injection.

### BACKGROUND

Public key cryptography, also known as asymmetric cryptography, is a cryptographic system that uses pairs of keys: a public key, which may be widely disseminated, and a private key, which is kept secret (e.g., accessible only to the owner). This system enables secure communication and authentication over insecure channels. In public key cryptography, the public key is used to encrypt data, which can then only be decrypted by the corresponding private key, ensuring that only the intended recipient can access the information. Conversely, data signed with a private key can be verified by anyone with the corresponding public key, providing a means of authentication and non-repudiation. Current algorithms used in public key cryptography include RSA (Rivest-Shamir-Adleman), ECC (Elliptic Curve Cryptography), and DSA (Digital Signature Algorithm).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for aerospace-based key injection, according to an embodiment.

FIG. 2 illustrates component interactions to implement an example of Derived Unique Key Per Transaction (DUKPT) use, according to an embodiment.

FIG. 3 illustrates an example of aerospace key injection, according to an embodiment.

FIG. 4 illustrates a flow diagram of an example of a method for aerospace-based key injection, according to an embodiment.

FIG. 5 is a block diagram illustrating an example of a machine upon which one or more embodiments may be implemented.

### DETAILED DESCRIPTION

Quantum cryptography leverages the principles of quantum mechanics to enhance the security of communication systems. Quantum cryptanalysis can reduce the effectiveness, or even defeat, some forms of encryption. For example, a threat to current cryptographic systems posed by quantum cryptoanalysis is Shor's algorithm. Developed by mathematician Peter Shor, this algorithm can efficiently factor large integers and compute discrete logarithms, tasks that form the basis of the security of widely used cryptographic schemes like RSA and ECC. Shor's algorithm, running on a sufficiently powerful quantum computer, could break these encryption methods, rendering them insecure. As a result, the development of quantum-resistant cryptographic algorithms, also known as post-quantum cryptography, is a critical area of research to ensure data security in the future quantum era.

Terminals, such as point-of-sale (POS) terminals or Automated Teller Machines (ATMs), use encryption strategies to ensure secure transactions because these devices often support payments, financial, healthcare, manufacturing, or other industrial services. Derived Unique Key Per Transaction (DUKPT) is an example of an key management technique that enhances security by generating a unique key for each transaction. DUKPT can use the Triple Data Encryption Algorithm (TDEA or 3DES) or Advanced Encryption Standard (AES) to encrypt data, leveraging a Base Derivation Key (BDK) and a unique Key Serial Number (KSN) for each terminal. The KSN, containing a terminal-specific identifier and a transaction counter, is transformed into an Initial Key (IK) using the BDK. Subsequent transaction-specific keys are derived from the IK, ensuring that each transaction is uniquely encrypted, thereby mitigating the risk of key compromise. Because DUKPT it is a symmetric key management system—e.g., DUKPT does not employ any asymmetric cryptography—DUKPT is resistant to a cryptographic relevant quantum computer (CRQC) that might be used for cryptanalysis to break a public key and derive a corresponding private key. Further, DUKPT solves the N-Squared problem where an endpoint communicating to N−1 endpoints needs to manage N−1 keys such that each endpoint uses a unique key for message protection. Rather, with DUKPT, the host system only needs a single BDK to support thousands or millions of endpoints, where each endpoint uses a unique IK to generation unique transaction keys (TKs) per message. DUKPT supports nonsequential messaging such that the host can process any message whether a previous message was undelivered or processed by another instance of the same host using the same BDK.

An issue arises in DUKPT where the number of TKs for a given IK are limited requiring rekeying of the device for continued use. There is limited space in the protocol to encode the transaction number, and thus there is an upper limit to the number of TKs that can be generated from an IK. At some point, the terminal will need a new IK if the terminal is to continue to encryption additional transactions. Traditionally, this issue was dealt with by either replacing the terminal or by injecting a new IK on the terminal. Because the IK is derived from the BDK, compromising the BDK is a serious issue. Thus, generally, the BDK is kept in a secured facility (e.g., a Key Injection Facility (KIF)), and the terminals are brought to this facility to receive a new IK. This process can be costly in terms of time and resources.

To address the inefficiency with current techniques for key injection, an aerospace-based key injection can be used. Here, an aerospace platform, such as a satellite or an aircraft, can have a BDK and generate an IK for a terminal upon a trigger (e.g., a request from the terminal). In the case of satellites, the security of the BDK is physically ensured by the difficulty in intercepting a satellite to physically access the satellite. For aircraft (e.g., a drone), BDK key security can be maintained by, for example, destroying the BDK when the aircraft has an indication that a landing is upcoming, such as a crash due to a loss of flight control. In both cases, the heightened position from which the aerospace platform operates provides both security to the BDK as well as convenient communication access to the terminals, thus reducing the resources used to install or refresh IPEKs (or other initial keys) to the terminals. Additional details and examples are provided below.

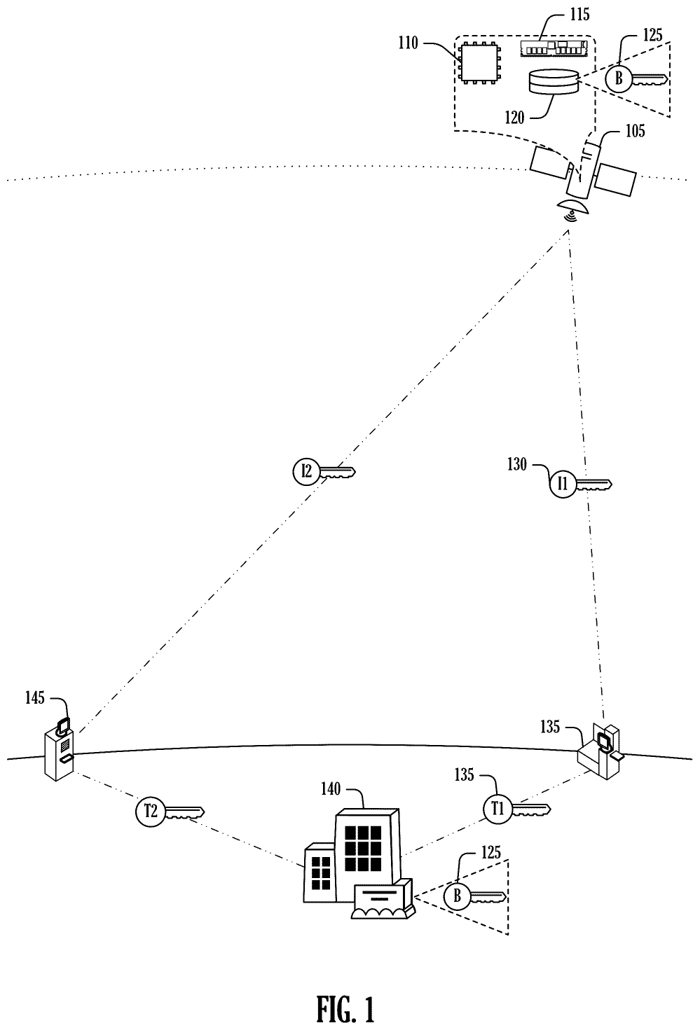

FIG. 1 is a block diagram of an example of an environment including a system 105 for aerospace-based key injection, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is generally discarded between system power cycles or restarts. The memory 115 and the storage 120 are both forms of computer readable media. The processing circuitry 110 or software residing in the memory 115 or storage 120 executing on the processing circuitry 110 configure the system 105 to perform various operations when in operation. The system 105 is a type of aerospace platform. In an example, the system is a satellite. In an example, the satellite has a geosynchronous orbit (e.g., a GEO satellite). In an example, the satellite has a low-Earth orbit (e.g., a LEO satellite). In an example, the aerospace platform is an aircraft. In an example, the aircraft is a drone (e.g., an unmanned remotely piloted or autonomous drone).

The processing circuitry 110 is configured to receive a request for an initial key 130 (e.g., IPEK or IK) is received from an entity, such as the POS terminal 135 or the ATM 145. This request includes an identifier that is unique among a set of entities to which the entity belongs. Here, the set of entities are those terminals for which the system 105 provides key injection services. In an example, the set of entities includes devices for which the BDK 125 is used. Thus, each of these entities has an identifier that uniquely identifies the entities from the other entities in the set. Ion the DUKPT exchange described herein, this identifier is used as a KSN for the entity.

The processing circuitry 110 is configured to obtain (e.g., retrieve or receive) the BDK 125 from the computer readable media (e.g., the storage 120 or the memory 115) of the system 105. Thus, the BDK 125 is held by the system 105 during injection operations. In an example, the BDK 125 is installed in the system 105 prior to launch. In an example, the BDK 125 is communicated to the system 105 after launch, for example, using a line-of-sight (e.g., narrow focus laser) or encryption technique to ensure the security of the BDK 125.

Because the BDK 125 is fundamental to the security of the symmetric key technique described herein, the security needs of the BDK 125 can outlive the system 105. Accordingly, in an example, the processing circuitry 110 is configured to destroy the BDK 125 based on (e.g., in response to) a trigger. In an example, the trigger is an indication of ceasing flight operations. For example, if the system 105 is an aircraft that experiences a flight problem, such as loss of engine power, the trigger is an indication of this flight problem. Here, the processing circuitry 110 erases, overwrites, or even detonates a small explosive to ensure that the BDK 125 is destroyed in order to prevent the BDK 125 from being retrieved from the downed system 105. Other triggers can include an indication that the system 105 is de-orbiting, an indication of power failure (e.g., dirty power preceding solar collector failures), an indication of a cybersecurity attack, or other operating faults. In an example, the trigger indicates a greater level of failure based on the difficulty of launching the system 105. For example, a GEO satellite has very little likelihood of coming back to Earth with the BDK 125 intact. Thus, the trigger can indicate an extreme event, such as a proximity detector indicating that the GEO satellite is actually and non-destructively captured while in orbit. However, the relative case with which a drone can be launch provides for a more ready trigger condition, such as an unaccounted for deviation (e.g., drift) in navigation.

The processing circuitry 110 is configured to generate the initial key (e.g., the initial key 130) for the entity (e.g., the POS terminal 135) based on the identifier from the original request and the locally stored BDK 125. In an example, the initial key is configured to support a DUKPT exchange for the entity.

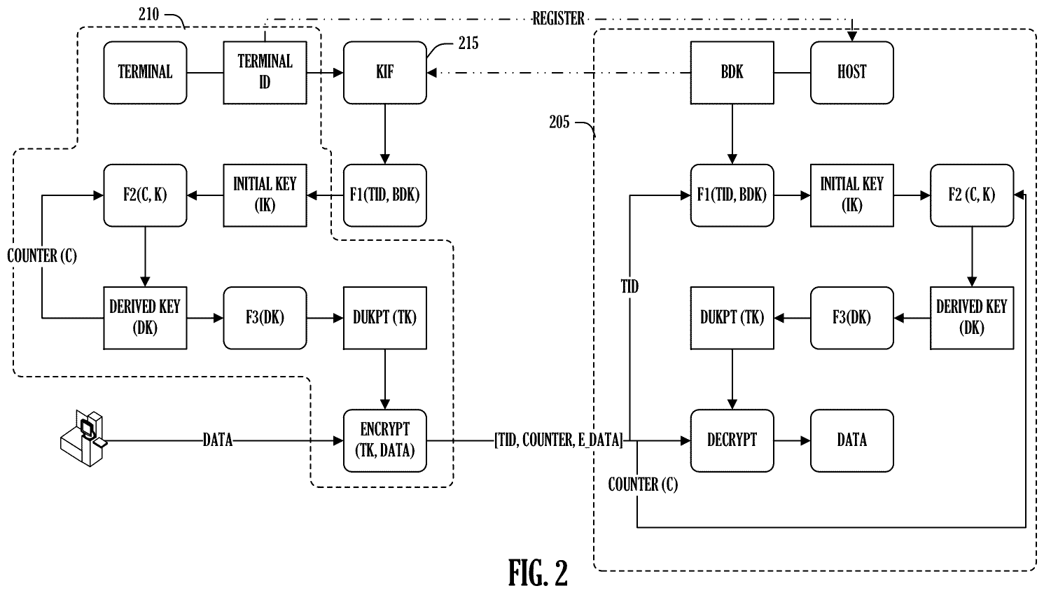

In an example, the BDK 125 is at a host device 140 configured to participate in the DUKPT exchange with the entity (e.g., the POS terminal 135). FIG. 2 provides a more in-depth discussion of DUKPT, but, in short, the host device 140 uses the BDK 125 to construct the same transaction key created by the terminal from the initial key provided by the system 105 as noted below. Thus, enabling the host device 140 and the POS terminal 135, for example, to use the independently generated but symmetrical transaction keys to secure communications. Accordingly, in an example, the entity (e.g., POS terminal 135) is configured to derive a transaction key from the initial key 130. In an example, the transaction key is used to encrypt data for a transaction. In an example, the transaction includes the identifier (e.g., the unique terminal identifier) and a counter indicative of the transaction. In an example, the host device 140 derives the transaction key based on the BDK 125 stored at the host device 140, the identifier, and the counter to decrypt the data.

The processing circuitry 110 is configured to transmit (e.g., via an interface to a transceiver of the system 105) the initial key (e.g., the initial key 130) is transmitted to the entity (e.g., the POS terminal 135). In an example, the processing circuitry 110 is configured to erase the initial key based on transmitting the initial key to the entity. This erasure can facilitate security similar to the trigger used to that described herein for destroying the BDK 125. However, because the initial key will not be used by the system 105 after a successful transmission to the entity, erasing the initial key from the system 105 provides a convenient way to ensure the security of the initial key while also saving on storage space in the system 105. In an example, the entity is configured to erase the initial key after creating a first transaction key. In an example, the entity could create all possible transaction keys from the initial key and store them locally. In these cases, there is no reason to keep the initial key and thus it is erased. However, if using DUKPT, each new derived key is derived using the derived key from the last transaction. Again, there is no need to keep the initial key, freeing up storage and providing an additional remove from the BDK.

In an example, transmitting the initial key to the entity includes using line-of-sight transceiver. In an example, the line-of-sight transceiver uses a laser. This technique ensures the physical security of the initial key by limiting the ability to receive the transmission of the initial key. In an example, transmitting the initial key to the entity includes using an encrypted channel. This channel may have been setup by, for example, a different IK producing TKs in which each transaction is a key injection (e.g., rekeying).

In an example, the host device 140 is configured to participate in the DUKPT exchange with the entity has a second BDK that is different than the base derivation key 125. In an example, the entity is configured to receive a second initial key from the host device 140, combine the initial key (e.g., the initial key 130) and the second initial key to create a third initial key. The entity can then derive a transaction key from the third initial key. In an example, to combine the initial key and the second initial key, the entity is configured to exclusive-OR (XOR) the initial key and the second initial key. In an example, the system 105 can use a separate BDK to send a first IK to the terminal and the HOST 140 can use another BDK to send a second IK to the same terminal, such that the terminal combines (e.g. XOR) the two IKs to derive a third IK used for DUKPT.

FIG. 2 illustrates component interactions to implement an example of Derived Unique Key Per Transaction (DUKPT) use, according to an embodiment. As illustrated, the terminal 210, the host 205, and the key injection facility 215 interact to implement the American National Standards Institute (ANSI) DUKPT family of standards for secure communication between the terminal 210 and the host 205. These standards cover the generation of unique transactions keys (e.g., TKs) from an initial terminal key (e.g., IK) such that the terminal does not preserve any information that could be used to derive the transaction key after the transaction has been completed. Further, the standard provides for host derivation of the same transaction keys using a bounded number of cryptographic operations.

More recent versions of the DUKPT standards provide an update to the original DUKPT technique through use of the AES algorithm to create the initial key. DUKPT can also employ TDEA to create the initial key. Key derivation can use either AES or TDEA as long as the same technique is used by both the terminal 210 and the host 205.

In operation, the host 205 obtains (e.g., retrieves, receives, creates, generates, etc.) a BDK. The BDK is provided (e.g., transmitted) to the KIF 215. The KIF 215 is typically a secure facility designed to ensure that the BDK is not shared, but, in the greater context of this document, the KIF 215 is an aerospace platform.

The terminal 210 registers a terminal identifier (TID), as optionally illustrated with the host 205, or with the KIF 215. When the TID is provided to the host 205, the host 205 then provides the TID to the KIF 215. In an example, the TID is provided to a third party provider from which the TID can be obtained by the host 205 or the KIF 215.

The KIF 215 uses F1—a function defined by the DUKPT standard—with the BDK and TID as input parameters, to generate the initial key (IK). The KIF 215 then provides, or injects, the IK to the terminal 210. Typically, for a terrestrial KIF 215, the injection occurs at the KIF facility and then the terminal 210 is physical moved (e.g., shipped) to a location (e.g., a merchant locations) for use.

The terminal 210 uses F2—another function defined by the DUKPT standards—with a key (K) and a counter (C) as inputs, to generate a derived key (DK). For the first DK, the key is the IK, such that K=IK and the counter is one, such that C=1. In subsequent iterations, the counter is incremented, and the last DK is used for the key. Thus, for example, the inputs to create a fourth DK (DK_4) are C=4 and K=DK_3.

The terminal 210 then uses F3—another function defined by the DUKPT standards—using the current DK as input, to create the transaction key (TK). The terminal 210 then uses this TK to encrypt data, such as the customer entered personal identification number (PIN) in a communication with the host. The TID, counter, and encrypted PIN (E_PIN) are all sent to the host 205.

The host 205 uses the TID from the communication in F1, with a local copy of the BDK, to recreate the IK. The host 205 then takes the counter from the communication, combines it with the IK in F2 to create the DK for this transaction. This transaction—specific to the terminal 210 and count (e.g., transaction number)—DK is used by the host 205 to reproduce the TK using F3. The host 205 then uses the TK to decrypt the encrypted payload, such as the E_PIN. At this point, the unencrypted data can then be used, such as, to verify whether or not the PIN is valid.

Generally, the host 205 can support thousands of terminals using the same BDK and because each TID is unique, and thus each IK, is unique per terminal. The terminal 210 and the host 205 can support millions of transactions using the same BDK and because each TK is unique per transaction, the same TK occurring at another terminal is purely happenstance. Once the DK are exhausted (e.g., the count is too large to fit in given transaction fields) a new IK can be injected.

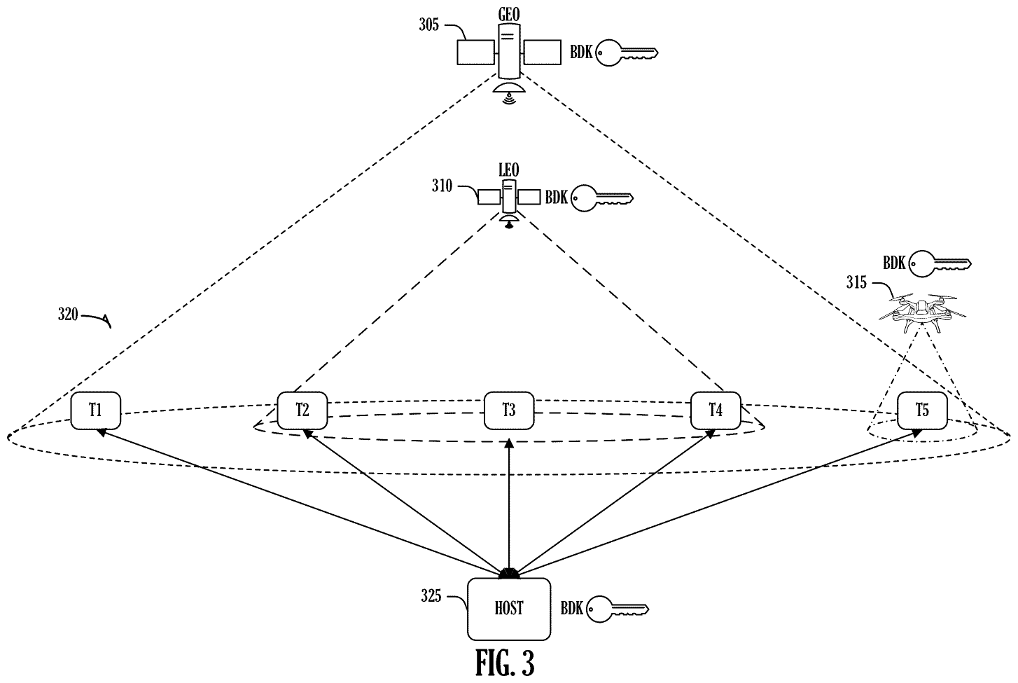

FIG. 3 illustrates an example of aerospace key injection, according to an embodiment. There are three different types of aerospace platforms illustrated along with different coverage areas for the terminals 320. The GEO satellite 305 has the broadest coverage area, the aircraft 315 the smallest coverage area, and the LEO satellite 310 somewhere in-between. Coverage areas can vary however, for the LEO satellite 310 and the aircraft 315 based on route traversal while remaining relatively fixed for the GEO satellite 305. Route traversal refers to the flight path of the aircraft 315 or the varying position above the Earth of the LEO satellite during orbit.

The illustrated arrangement uses an aerospace platform KIF to support DUKPT for multiple terminals interacting with a host 325. Each of the aerospace platforms and the host 325 have a copy of the same BDK to implement the DUKPT technique, such as that shown in FIG. 2. The aerospace platforms are deployed with a copy of the BDK to derive and inject the unique IKs into each of the terminal 320. Subsequently, per the DUKPT technique, each of the terminals 320 sends its identifier (TID), a counter, and encrypted data (e.g., ciphertext) using a derived unique key per transaction (TK) to the host 325. The host 325 uses the TID to re-derive the IK from the BDK, then uses the counter and the re-derived IK to re-derive the TK, and then decrypts the ciphertext data using the TK to process the cleartext.

In an example, the GEO satellite 305, the LEO satellite 310, or the aircraft 315 are supplied with the BDK prior to launch (e.g., into orbit or on a flight path). As an aerospace platform the terminals 320, a TID is provided, or confirmed, by each of the terminals 320. For example, the host 325 can provide a TID list to the satellites for verification with the terminals 320, or the host 325 can perform TID verification as a service to the satellite. Thus, for the LEO satellite 310, the LEO satellite 310 can receive the TID from the terminal (e.g., T2) on the first pass, verify the TID with the host 325, and then inject the IK on a second pass over the terminal. The aerospace platform can then create a unique IK for each of the terminals 320 based on the TIDs, and then transmit the IK to the respective terminals 320. With the reception of an IK, the terminals 320 can start deriving the TKs using the IK. Because, the IK is generally used once, for the first DK, the terminals can destroy the IK such that, for example, the only keys stored in the terminal are unused keys.

In an example, once an IK is delivered to a given terminal, the aerospace platform destroys the IK such that the only key stored in the aerospace platform is the BDK, or other BDKs in the case where the aerospace platform supports multiple hosts with different BDKs.

As noted above, once the IKs are distributed to the appropriate terminals 320, each terminal can send its TID, a transaction count, and encrypted data (ciphertext) using the TK to the host 325 where the host 325 can decrypt the encrypted data. In an example, instead of, or in addition to, encryption, the symmetric TK can be used for message authentication, such as message authentication codes (MAC) or hash-based MAC (HMAC) to protect content. Generally, the host 325 only stores the BDK and can re-generate a given TK given the TID and the transaction count. This enables the host 325 to communicate with thousands or millions of terminals 320. Because the BDK is only available to the host 325 and the KIF (e.g., the aerospace platforms), the terminals 320 never access the BDK, enhancing security of the technique. BDK security in satellite based KIFs is often addressed by the destruction of the satellite during re-entry at the satellite's end of life. For the aircraft 315, or reusable satellites, BDK key security can be handled via physical destruction, erasure, or through other cryptographic techniques when the key injection mission is complete.

Because the IK the basis (e.g., starting point) for the DKs and thus TKs produced by the terminals 320, a third party that intercepts the IK could decrypt communicates for a given terminal. To protect the IKs while being transmitted to the terminals from the aerospace platforms, a variety of techniques can be used. For example, line-of-sight (e.g. laser) communications can be used to physically restrict recipients to the transmission. In an example, the IK can be piggybacked onto existing secure communication protocols. In an example, a separate BDK can be used by the aerospace platform to send a first IK to a terminal and the host 325 uses a second BDK to send a second IK to the same terminal. Here, the terminal can combine the two IKs (e.g. using XOR) to derive a third IK that is then used DUKPT. Here, the host 325 has both BDKs to derive the third IK from the TID.

These approaches have several advantages. For example, aerospace key injection supports the proven DUKPT symmetric key management using satellites or aircraft. This means that the technique is quantum-resistant for terminals-to-host transactions and supports thousands or millions of terminals 320 for each combination of host 325 and BDK. Further, the aerospace platform can support multiple BDKs for the host 325 or for multiple hosts. All of this supports a secure infrastructure without the resources used to support current terminal-to-host infrastructure arrangements.

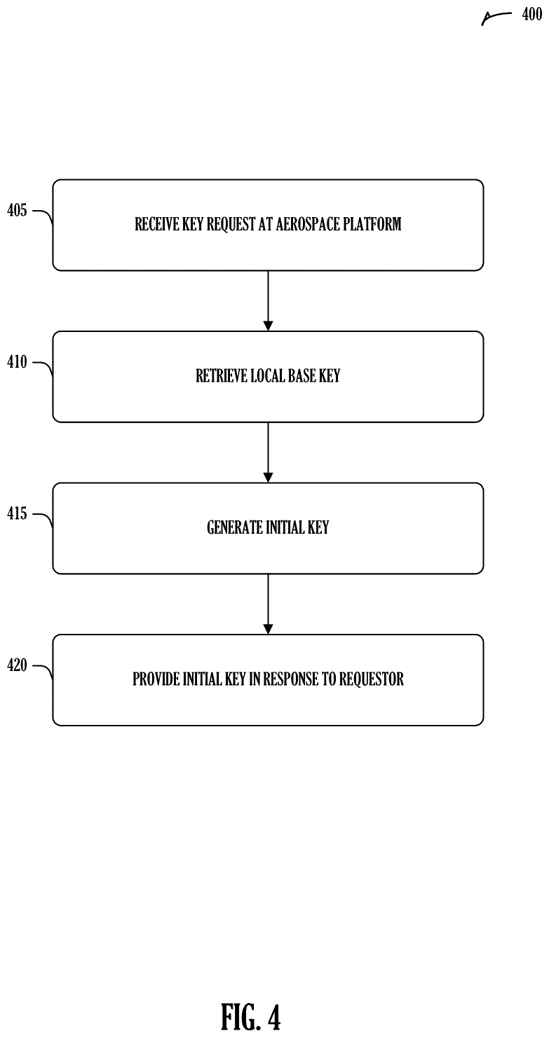

FIG. 4 illustrates a flow diagram of an example of a method 400 for aerospace-based key injection, according to an embodiment. The operations of the method 400 are implemented in computer hardware, such as that described above or below.

At operation 405, a request for an initial key is received, by an aerospace platform, from an entity. This request includes an identifier that is unique among a set of entities to which the entity belongs. In an example, the aerospace platform is a satellite. In an example, the satellite is a low Earth orbit (LEO) satellite. In an example, the satellite is a geosynchronous satellite. In an example, the aerospace platform is a drone.

At operation 410, a base derivation key is retrieved from computer readable media of the aerospace platform. In an example, the operations of the method 400 include destroying the base derivation key in response to a trigger. In an example, the trigger is an indication of ceasing flight operations.

In an example, the base derivation key is at a host device configured to participate in the DUKPT exchange with the entity. In an example, the entity is configured to derive a transaction key from the initial key. In an example, the transaction key is used to encrypt data for a transaction. In an example, the transaction key includes the identifier and a counter indicative of the transaction. In an example, the host derives the transaction key based on the base derivation key, the identifier, and the counter to decrypt the data. In an example, the entity is configured to erase the initial key after creating a first transaction key.

In an example, a host configured to participate in the DUKPT exchange with the entity has a second base derivation key that is different than the base derivation key. In an example, the entity is configured to receive a second initial key from the host, combine the initial key and the second initial key to create a third initial key, and derive a transaction key from the third initial key. In an example, to combine the initial key and the second initial key, the entity is configured to exclusive-OR (XOR) the initial key and the second initial key.

At operation 415, an initial key is generated for the entity based on the identifier and the base derivation key. This initial key is configured to support a Derived Unique Key Per Transaction (DUKPT) exchange for the entity.

At operation 420, the initial key is transmitted to the entity. In an example, the operations of the method 400 include erasing (e.g., zeroizing) the initial key based on successfully transmitting the initial key to the entity. In an example, transmitting the initial key to the entity includes using line-of-sight transceiver. In an example, the line-of-sight transceiver uses a laser. In an example, transmitting the initial key to the entity includes using an encryption protected technique (e.g., an encrypted channel) or otherwise protected technique (e.g., a secure side-band, physically constrained communication, etc.).

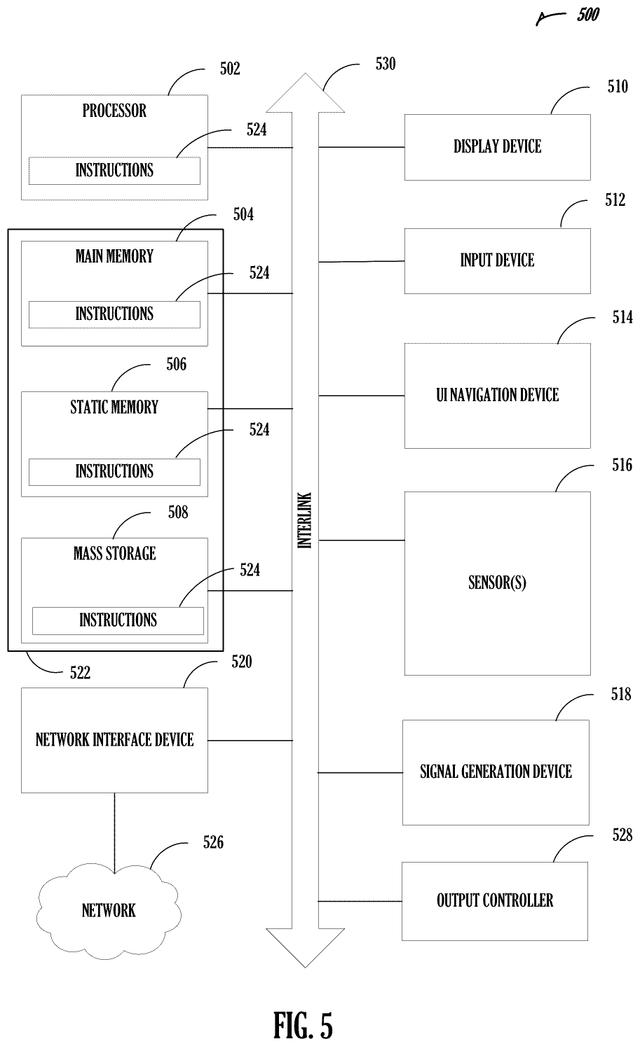

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In an example, the machine 500 includes a hardware security module (HSM) or is itself an HSM or embedded within an HSM.

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is a machine readable medium including instructions for aerospace-based key injection, the instructions, when executed by processing circuitry, cause the processing circuitry to perform operations comprising: receiving, at an aerospace platform, a request for an initial key from an entity, the request including an identifier that is unique among a set of entities to which the entity belongs; retrieving, from storage of the aerospace platform, a base derivation key; generating an initial key for the entity based on the identifier and the base derivation key, the initial key configured to support a Derived Unique Key Per Transaction (DUKPT) exchange for the entity; and transmitting the initial key to the entity.

In Example 2, the subject matter of Example 1, wherein the aerospace platform is a satellite.

In Example 3, the subject matter of Example 2, wherein the satellite is a low Earth orbit (LEO) satellite.

In Example 4, the subject matter of any of Examples 2-3, wherein the satellite is a geosynchronous satellite.

In Example 5, the subject matter of any of Examples 1-4, wherein the aerospace platform is a drone.

In Example 6, the subject matter of any of Examples 1-5, wherein the operations comprise destroying the base derivation key in response to a trigger.

In Example 7, the subject matter of Example 6, wherein the trigger is an indication of ceasing flight operations.

In Example 8, the subject matter of any of Examples 1-7, wherein the operations comprise erasing the initial key based on transmitting the initial key to the entity.

In Example 9, the subject matter of any of Examples 1-8, wherein the base derivation key is at a host device configured to participate in the DUKPT exchange with the entity.

In Example 10, the subject matter of Example 9, wherein the entity is configured to derive a transaction key from the initial key, wherein the transaction key is used to encrypt data for a transaction, wherein the transaction key includes the identifier and a counter indicative of the transaction, and wherein the host device derives the transaction key based on the base derivation key, the identifier, and the counter to decrypt the data.

In Example 11, the subject matter of Example 10, wherein the entity is configured to erase the initial key after creating a first transaction key.

In Example 12, the subject matter of any of Examples 1-11, wherein a host configured to participate in the DUKPT exchange with the entity has a second base derivation key that is different than the base derivation key.

In Example 13, the subject matter of Example 12, wherein the entity is configured to: receive a second initial key from the host; combine the initial key and the second initial key to create a third initial key; and derive a transaction key from the third initial key.

In Example 14, the subject matter of Example 13, wherein, to combine the initial key and the second initial key, the entity is configured to exclusive-OR (XOR) the initial key and the second initial key.

In Example 15, the subject matter of any of Examples 1-14, wherein transmitting the initial key to the entity includes using line-of-sight transceiver.

In Example 16, the subject matter of Example 15, wherein the line-of-sight transceiver uses a laser.

In Example 17, the subject matter of any of Examples 1-16, wherein transmitting the initial key to the entity includes using an encrypted channel.

Example 18 is a device for aerospace-based key injection, the device comprising: a first interface to a transceiver; a second interface to storage; and processing circuitry configured to: receive, from the transceiver via the first interface, a request for an initial key from an entity, the request including an identifier that is unique among a set of entities to which the entity belongs; retrieve, from the storage via the second interface, a base derivation key; generate an initial key for the entity based on the identifier and the base derivation key, the initial key configured to support a Derived Unique Key Per Transaction (DUKPT) exchange for the entity; and transmit, via the first interface to the transceiver, the initial key to the entity, the device configured to be operated from an aerospace platform.

In Example 19, the subject matter of Example 18, wherein the aerospace platform is a satellite.

In Example 20, the subject matter of Example 19, wherein the satellite is a low Earth orbit (LEO) satellite.

In Example 21, the subject matter of any of Examples 19-20, wherein the satellite is a geosynchronous satellite.

In Example 22, the subject matter of any of Examples 18-21, wherein the aerospace platform is a drone.

In Example 23, the subject matter of any of Examples 18-22, wherein the processing circuitry is configured to destroy the base derivation key in response to a trigger.

In Example 24, the subject matter of Example 23, wherein the trigger is an indication of ceasing flight operations.

In Example 25, the subject matter of any of Examples 18-24, wherein the processing circuitry is configured to erase the initial key based on transmitting the initial key to the entity.

In Example 26, the subject matter of any of Examples 18-25, wherein the base derivation key is at a host device configured to participate in the DUKPT exchange with the entity.

In Example 27, the subject matter of Example 26, wherein the entity is configured to derive a transaction key from the initial key, wherein the transaction key is used to encrypt data for a transaction, wherein the transaction key includes the identifier and a counter indicative of the transaction, and wherein the host device derives the transaction key based on the base derivation key, the identifier, and the counter to decrypt the data.

In Example 28, the subject matter of Example 27, wherein the entity is configured to erase the initial key after creating a first transaction key.

In Example 29, the subject matter of any of Examples 18-28, wherein a host configured to participate in the DUKPT exchange with the entity has a second base derivation key that is different than the base derivation key.

In Example 30, the subject matter of Example 29, wherein the entity is configured to: receive a second initial key from the host; combine the initial key and the second initial key to create a third initial key; and derive a transaction key from the third initial key.

In Example 31, the subject matter of Example 30, wherein, to combine the initial key and the second initial key, the entity is configured to exclusive-OR (XOR) the initial key and the second initial key.

In Example 32, the subject matter of any of Examples 18-31, wherein the transceiver includes a line-of-sight transmitter.

In Example 33, the subject matter of Example 32, wherein the line-of-sight transmitter uses a laser.

In Example 34, the subject matter of any of Examples 18-33, wherein, to transmit the initial key to the entity, the processing circuitry is configured to use an encrypted channel.

Example 35 is a method for aerospace-based key injection, the method comprising: receiving, at processing circuitry on an aerospace platform, a request for an initial key from an entity, the request including an identifier that is unique among a set of entities to which the entity belongs; retrieving, from computer readable media of the aerospace platform, a base derivation key; generating an initial key for the entity based on the identifier and the base derivation key, the initial key configured to support a Derived Unique Key Per Transaction (DUKPT) exchange for the entity; and transmitting the initial key to the entity.

In Example 36, the subject matter of Example 35, wherein the aerospace platform is a satellite.

In Example 37, the subject matter of Example 36, wherein the satellite is a low Earth orbit (LEO) satellite.

In Example 38, the subject matter of any of Examples 36-37, wherein the satellite is a geosynchronous satellite.

In Example 39, the subject matter of any of Examples 35-38, wherein the aerospace platform is a drone.

In Example 40, the subject matter of any of Examples 35-39, comprising destroying the base derivation key in response to a trigger.

In Example 41, the subject matter of Example 40, wherein the trigger is an indication of ceasing flight operations.

In Example 42, the subject matter of any of Examples 35-41, comprising erasing the initial key based on transmitting the initial key to the entity.

In Example 43, the subject matter of any of Examples 35-42, wherein the base derivation key is at a host device configured to participate in the DUKPT exchange with the entity.

In Example 44, the subject matter of Example 43, wherein the entity is configured to derive a transaction key from the initial key, wherein the transaction key is used to encrypt data for a transaction, wherein the transaction key includes the identifier and a counter indicative of the transaction, and wherein the host device derives the transaction key based on the base derivation key, the identifier, and the counter to decrypt the data.

In Example 45, the subject matter of Example 44, wherein the entity is configured to erase the initial key after creating a first transaction key.

In Example 46, the subject matter of any of Examples 35-45, wherein a host configured to participate in the DUKPT exchange with the entity has a second base derivation key that is different than the base derivation key.

In Example 47, the subject matter of Example 46, wherein the entity is configured to: receive a second initial key from the host; combine the initial key and the second initial key to create a third initial key; and derive a transaction key from the third initial key.

In Example 48, the subject matter of Example 47, wherein, to combine the initial key and the second initial key, the entity is configured to exclusive-OR (XOR) the initial key and the second initial key.

In Example 49, the subject matter of any of Examples 35-48, wherein transmitting the initial key to the entity includes using line-of-sight transceiver.

In Example 50, the subject matter of Example 49, wherein the line-of-sight transceiver uses a laser.

In Example 51, the subject matter of any of Examples 35-50, wherein transmitting the initial key to the entity includes using an encrypted channel.

Example 52 is a system for aerospace-based key injection, the system comprising: means for receiving, at an aerospace platform, a request for an initial key from an entity, the request including an identifier that is unique among a set of entities to which the entity belongs; means for retrieving, from local storage of the aerospace platform, a base derivation key; means for generating an initial key for the entity based on the identifier and the base derivation key, the initial key configured to support a Derived Unique Key Per Transaction (DUKPT) exchange for the entity; and means for transmitting the initial key to the entity.

In Example 53, the subject matter of Example 52, wherein the aerospace platform is a satellite.

In Example 54, the subject matter of Example 53, wherein the satellite is a low Earth orbit (LEO) satellite.

In Example 55, the subject matter of any of Examples 53-54, wherein the satellite is a geosynchronous satellite.

In Example 56, the subject matter of any of Examples 52-55, wherein the aerospace platform is a drone.

In Example 57, the subject matter of any of Examples 52-56, comprising means for destroying the base derivation key in response to a trigger.

In Example 58, the subject matter of Example 57, wherein the trigger is an indication of ceasing flight operations.

In Example 59, the subject matter of any of Examples 52-58, comprising means for erasing the initial key based on transmitting the initial key to the entity.

In Example 60, the subject matter of any of Examples 52-59, wherein the base derivation key is at a host device configured to participate in the DUKPT exchange with the entity.

In Example 61, the subject matter of Example 60, wherein the entity is configured to derive a transaction key from the initial key, wherein the transaction key is used to encrypt data for a transaction, wherein the transaction key includes the identifier and a counter indicative of the transaction, and wherein the host device derives the transaction key based on the base derivation key, the identifier, and the counter to decrypt the data.

In Example 62, the subject matter of Example 61, wherein the entity is configured to erase the initial key after creating a first transaction key.

In Example 63, the subject matter of any of Examples 52-62, wherein a host configured to participate in the DUKPT exchange with the entity has a second base derivation key that is different than the base derivation key.

In Example 64, the subject matter of Example 63, wherein the entity is configured to: receive a second initial key from the host; combine the initial key and the second initial key to create a third initial key; and derive a transaction key from the third initial key.

In Example 65, the subject matter of Example 64, wherein, to combine the initial key and the second initial key, the entity is configured to exclusive-OR (XOR) the initial key and the second initial key.

In Example 66, the subject matter of any of Examples 52-65, wherein the means for transmitting the initial key to the entity include means for using line-of-sight transceiver.

In Example 67, the subject matter of Example 66, wherein the line-of-sight transceiver uses a laser.

In Example 68, the subject matter of any of Examples 52-67, wherein the means for transmitting the initial key to the entity include means for using an encrypted channel.

Example 69 is at least one machine-readable medium including instructions that, when executed by processing circuitry, cause the processing circuitry to perform operations to implement of any of Examples 1-68.

Example 70 is an apparatus comprising means to implement of any of Examples 1-68.

Example 71 is a system to implement of any of Examples 1-68.

Example 72 is a method to implement of any of Examples 1-68.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory machine readable medium including instructions for aerospace-based key injection, the instructions, when executed by processing circuitry, cause the processing circuitry to perform operations comprising:
receiving, at an aerospace platform, a request for an initial key from an entity, the request including an identifier that is unique among a set of entities to which the entity belongs;
retrieving, from storage of the aerospace platform, a base derivation key;
generating an initial key for the entity based on the identifier and the base derivation key, the initial key configured to support a Derived Unique Key Per Transaction (DUKPT) exchange for the entity; and
transmitting the initial key to the entity.

2. The non-transitory machine readable medium of claim 1, wherein the aerospace platform is a satellite.

3. The non-transitory machine readable medium of claim 2, wherein the satellite is a low Earth orbit (LEO) satellite.

4. The non-transitory machine readable medium of claim 2, wherein the satellite is a geosynchronous satellite.

5. The non-transitory machine readable medium of claim 1, wherein the aerospace platform is a drone.

6. The non-transitory machine readable medium of claim 1, wherein the operations comprise destroying the base derivation key in response to a trigger.

7. The non-transitory machine readable medium of claim 6, wherein the trigger is an indication of ceasing flight operations.

8. The non-transitory machine readable medium of claim 1, wherein the operations comprise erasing the initial key based on transmitting the initial key to the entity.

9. The machine readable medium of claim 1, wherein the base derivation key is at a host device configured to participate in the DUKPT exchange with the entity.

10. The non-transitory machine readable medium of claim 9, wherein the entity is configured to derive a transaction key from the initial key, wherein the transaction key is used to encrypt data for a transaction, wherein the transaction key includes the identifier and a counter indicative of the transaction, and wherein the host device derives the transaction key based on the base derivation key, the identifier, and the counter to decrypt the data.

11. The non-transitory machine readable medium of claim 10, wherein the entity is configured to erase the initial key after creating a first transaction key.

12. The non-transitory machine readable medium of claim 1, wherein a host configured to participate in the DUKPT exchange with the entity has a second base derivation key that is different than the base derivation key.

13. The non-transitory machine readable medium of claim 12, wherein the entity is configured to:
receive a second initial key from the host;
combine the initial key and the second initial key to create a third initial key; and
derive a transaction key from the third initial key.

14. The non-transitory machine readable medium of claim 13, wherein, to combine the initial key and the second initial key, the entity is configured to exclusive-OR (XOR) the initial key and the second initial key.

15. The non-transitory machine readable medium of claim 1, wherein transmitting the initial key to the entity includes using line-of-sight transceiver.

16. The non-transitory machine readable medium of claim 15, wherein the line-of-sight transceiver uses a laser.

17. The non-transitory machine readable medium of claim 1, wherein transmitting the initial key to the entity includes using an encrypted channel.

18. A device for aerospace-based key injection, the device comprising:
a first interface to a transceiver;
a second interface to storage; and
processing circuitry configured to:
receive, from the transceiver via the first interface, a request for an initial key from an entity, the request including an identifier that is unique among a set of entities to which the entity belongs;
retrieve, from the storage via the second interface, a base derivation key;
generate an initial key for the entity based on the identifier and the base derivation key, the initial key configured to support a Derived Unique Key Per Transaction (DUKPT) exchange for the entity; and
transmit, via the first interface to the transceiver, the initial key to the entity, the device configured to be operated from an aerospace platform.

19. The device of claim 18, wherein the processing circuitry is configured to destroy the base derivation key in response to a trigger.

20. The device of claim 18, wherein a host configured to participate in the DUKPT exchange with the entity has a second base derivation key that is different than the base derivation key.
